(19) United States
(12) Patent Application Publication
(10) Pub. No.: US 2015/0068689 A1
(43) Pub. Date: Mar. 12, 2015

(54) CORD LOCKER OF ROMAN SHADE

(71) Applicant: NIEN MADE ENTERPRISE CO., LTD., Taichung (TW)

(72) Inventor: De-Jun ZHANG, Taichung (TW)

(73) Assignee: NIEN MADE ENTERPRISE CO., LTD., Taichung (TW)

(21) Appl. No.: 14/019,747

(22) Filed: Sep. 6, 2013

(51) Int. Cl. E06B 9/324

(52) U.S. Cl. CPC E06B 9/324
USPC 160/178.2

(57) ABSTRACT

A cord locker of a roman shade includes a base, a rotary member and a connector. The connector is fixed to a shade member of the roman shade, and the base is connected to the connector. The rotary member is pivoted on the base to let the cord passes through between the rotary member and the base. While the cord is pulled, it will turn the rotary member and make the rotary member press the cord onto the base. As a result, the cord is unable to be pulled anymore in a very short time.

### BACKGROUND OF THE INVENTION

1. Field of the Invention

The present invention relates generally to a window covering, and more particularly to a cord locker of a roman shade.

2. Description of the Related Art

Typically, a conventional roman shade is provided with a shade member and a plurality of cords fastened at a back side of the shade member that the shade member may have a clear look. The shade member usually is provided with rings at the back side for the cords to pass through. Theses rings are hook-like members, which may disengage the cords while the cord is pulled to prevent the shade member from being damaged by the cords and avoid an accident while the kid pull out the cord and wind it around his/her neck. Another conventional roman shade is provided with a double-layer shade member, and the cords are received in the shade member so that no one is able to touch the cords. Some shade members are provided with cord tubes to receive the cords therein.

However, there still are some unsolved problems in the conventional roman shade, such as how much transverse force is needed to disengage the cords with the rings? It is hard to calculate and manufacture. For the roman shade with double-layer shade member or cord tubes, it makes the cost of the roman shades higher, and makes them heavier.

### SUMMARY OF THE INVENTION

The primary objective of the present invention is to provide a cord locker of a roman shade, which connects the cord to the shade member in a safe and easy way, and makes the cord unable to be pulled out thus make it a safe product.

According to the objective of the present invention, a cord locker of a roman shade includes a base and a rotary member. The base has two protrusions and a resting face. The protrusions are on the same side of the base and face each other. The rotary member is pivoted on the base and between the protrusions. The rotary member has a top end and a bottom end, whereby a distance between the top end and the resting face and a distance between the bottom end and the resting face will change when the rotary member is turned.

In an embodiment, each protrusion of the base has a hole; the rotary member has a board and two posts on opposite sides of the board; and the posts engage the holes of the protrusions respectively.

In an embodiment, the cord locker further includes a wear-resisting member attached to the rotary member and facing the resting face of the base.

In an embodiment, the base has a transverse plate and two lateral plates on opposite ends of the transverse plate; the resting face is formed on a side of the transverse plate; and the protrusions are provided on the lateral plates respectively.

In an embodiment, the cord locker further includes a connector having two arms and two hooks on distal ends of the arms. The transverse plate has a bore, and each lateral plate has an opening; and the arms of the connector pass through the bore of the transverse plate, and then the hooks engage the openings of the lateral plates respectively.

In an embodiment, the cord locker further includes at least a clipping arm on the transverse plate of the base, wherein the clipping arm is on a side which is opposite to the resting face.

In an embodiment, the cord locker further includes two clipping arms on the transverse plate of the base, wherein the clipping arms are on a side which is opposite to the resting face, and a clipping space is formed between the clipping arms.

In an embodiment, the base has a bore, and each protrusion has a hole communicated with the bore; the rotary member has a portion received in the bore and has a portion out of the bore; a post is provided on the portion of the rotary member in the bore to engage the holes of the protrusions; a cord hole is provided on the portion of the rotary member out of the bore for a cord passing there through.

The design of the cord locker connects the cord to the shade member in a safe and easy way, and furthermore it may lower the cost.

### BRIEF DESCRIPTION OF THE DRAWINGS

FIG. 1 is a perspective view of the roman shade of a first preferred embodiment of the present invention;

FIG. 2 is a perspective view of the cord locker of the first preferred embodiment of the present invention;

FIG. 3 is a sectional view along the 3-3 line of FIG. 2;

FIG. 4 and FIG. 5 are exploded views of the cord locker of the first preferred embodiment of the present invention;

FIG. 6 is a sectional view of the cord locker of the first preferred embodiment of the present invention, showing the rotary member being pulled out by the cord;

FIG. 7 is a perspective view of the cord locker of a second preferred embodiment of the present invention;

FIG. 8 is a perspective view of the cord locker of a third preferred embodiment of the present invention; and

FIG. 9 is a perspective view of the cord locker of a fourth preferred embodiment of the present invention.

### DETAILED DESCRIPTION OF THE INVENTION

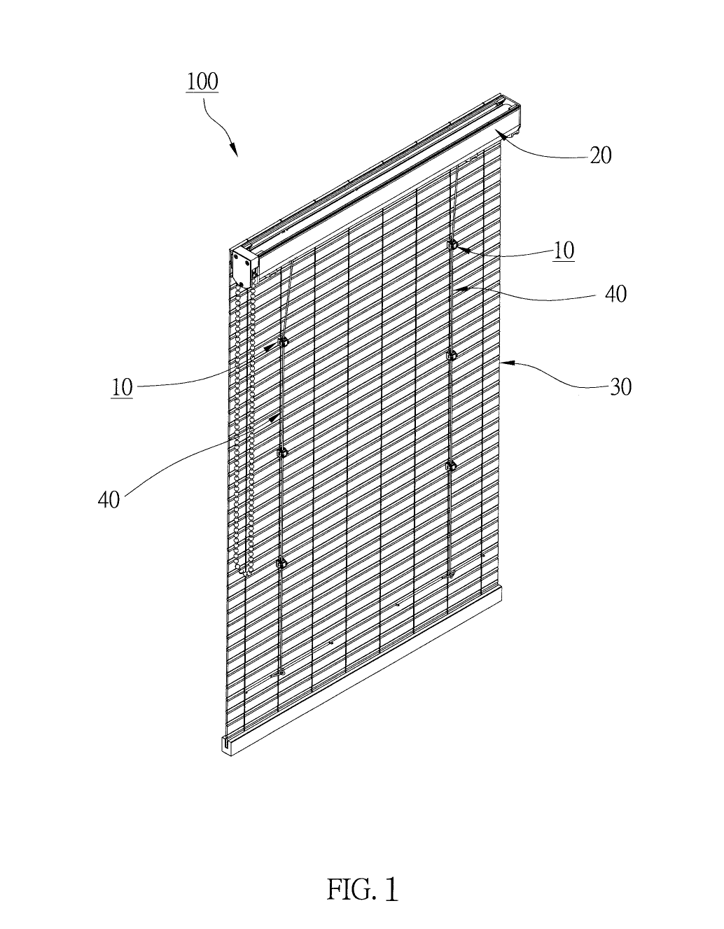

FIG. 1 shows a roman shade 100 which is provided with a plurality of cord lockers 10 of the first preferred embodiment of the present invention. The roman shade 100 includes a headrail 20, a shade member 30, and two cords 40. The cord lockers 10 are connected to a back side of the shade member 30 in two rows for the cords 40 to pass through. Each cord 40 has an end connected to a drum (not shown) in the headrail 20 and the other end fastened to a bottom end of the shade member 30.

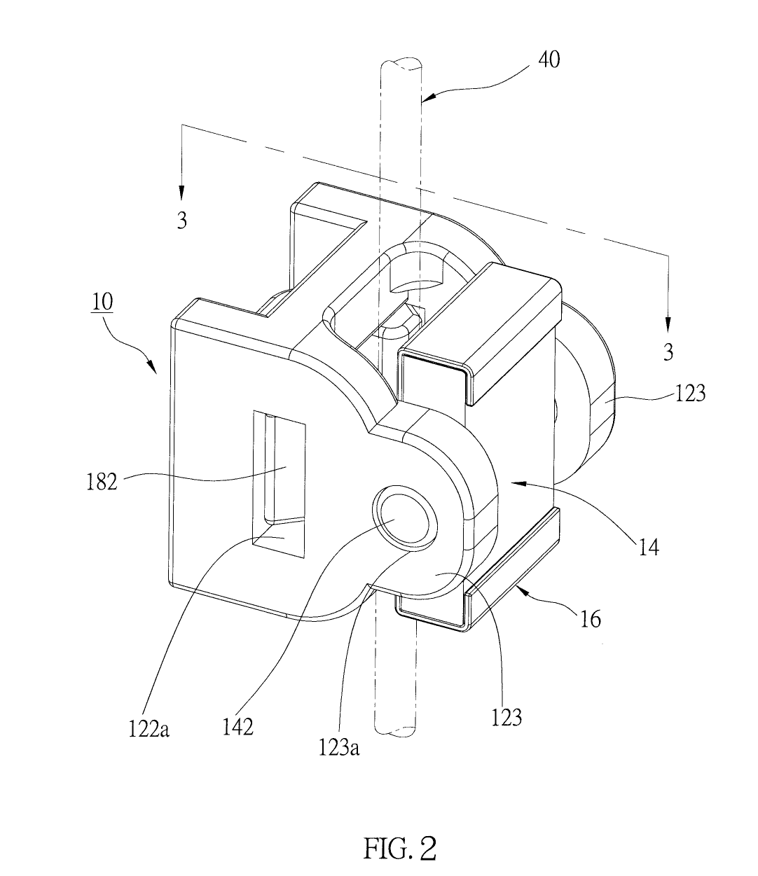

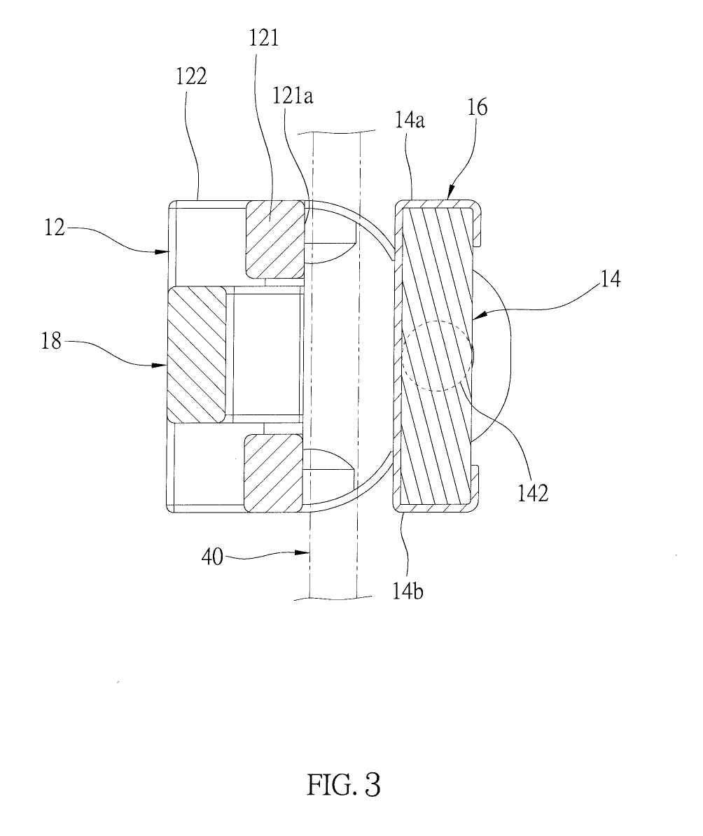

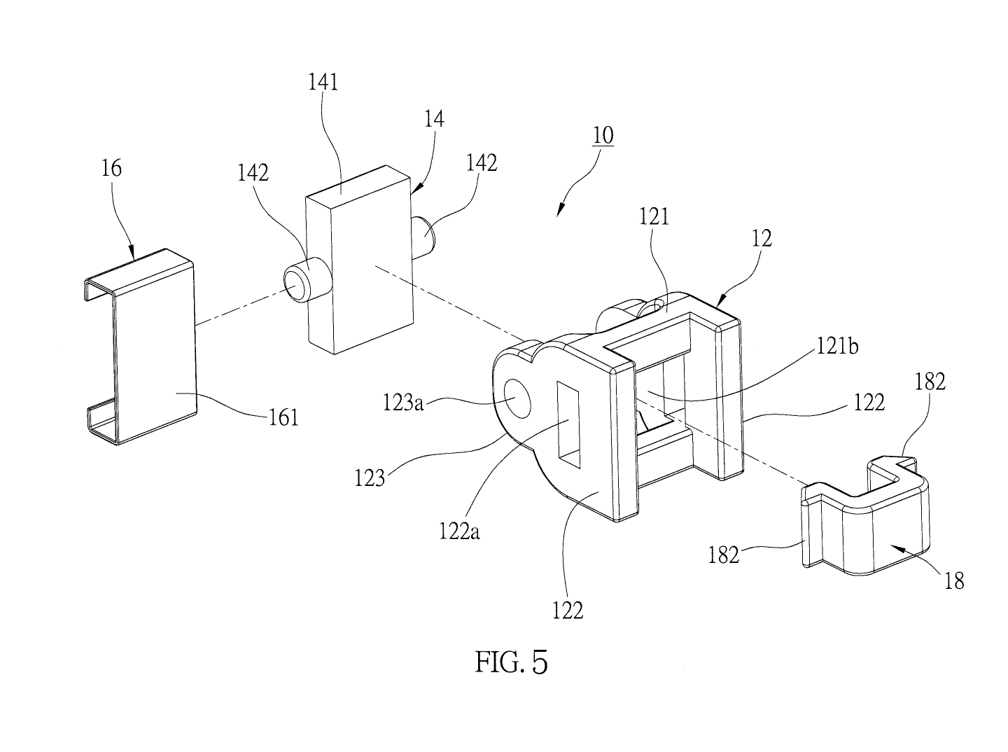

As shown in FIG. 2 to FIG. 5, the cord locker 10 has a base 12, a rotary member 14, a wear-resisting member 16, and a connector 18. The base 12 has a transverse plate 121 and two lateral plates 122 to form an H-shaped member. The transverse plate 121 has a resting face 121a and a bore 121b. The lateral plates 122 are parallel to each other, and are on opposite ends of the transverse plate 121. Each lateral plate 122 has an opening 122a and a protrusion 123 on a distal end thereof. The protrusion 123 has a hole 123a.

The rotary member 14 has a board 141 and two posts 142. The board 141 is a rectangular member, and the posts 142 are on opposite ends of the board 141. The posts 142 engage the holes 123a of the protrusions 123 respectively to pivot the board 141 on the base 12. The rotary member 14 has a top end 14a and a bottom end 14b. A distance between the top end 14a and the resting face 121a and a distance between the bottom end 14b and the resting face 121a are changeable by turning the rotary member 14. The cord 40 passes through a gap between the rotary member 14 and the transverse plate 121 of the base 12.

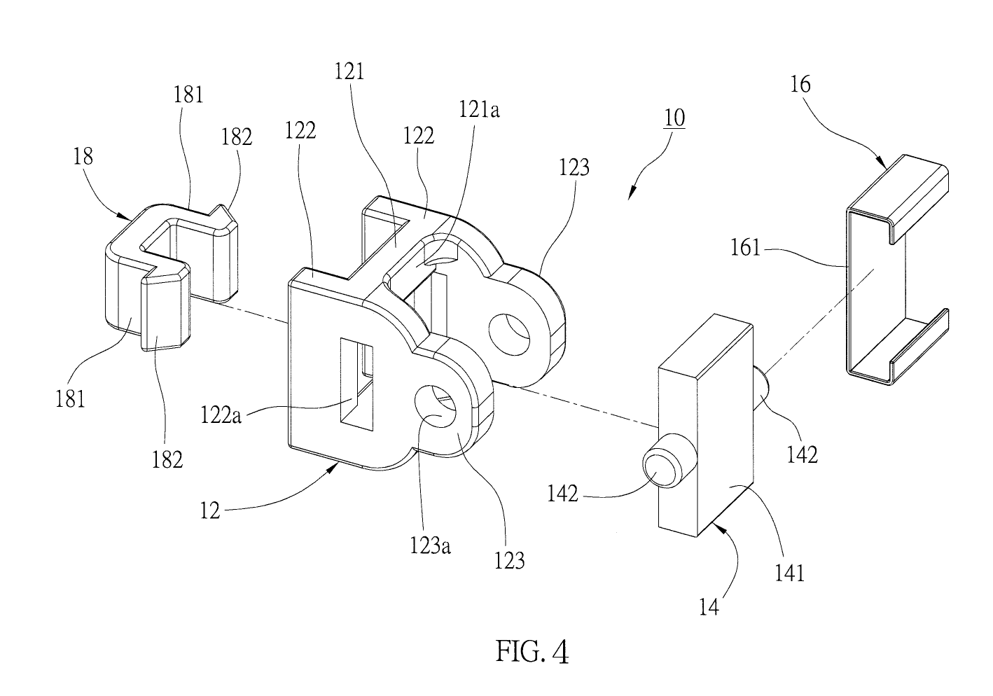

The wear-resisting member 16 is an optional accessory to be secured to the board 141. As shown in FIG. 4, the wear-resisting member 16 has a front plate 161 facing the resting face 121a of the base 12. The wear-resisting member 16 protects the cord 40 to reduce the damage of wearing and tearing.

The connector 18 is fixed to the back side of the shade member 30, as shown in FIG. 4, which has two flexible arms 181 and two hooks 182 on distal ends of the arms 181. The arms 181 pass through the bore 121b of the transverse plate 121, and then the hooks 182 engage the openings 122a of the lateral plates 122 respectively to secure the base 12 to the connector 18. The arms 181 are able to be pressed inwards to disengage the base 12 with the connector 18.

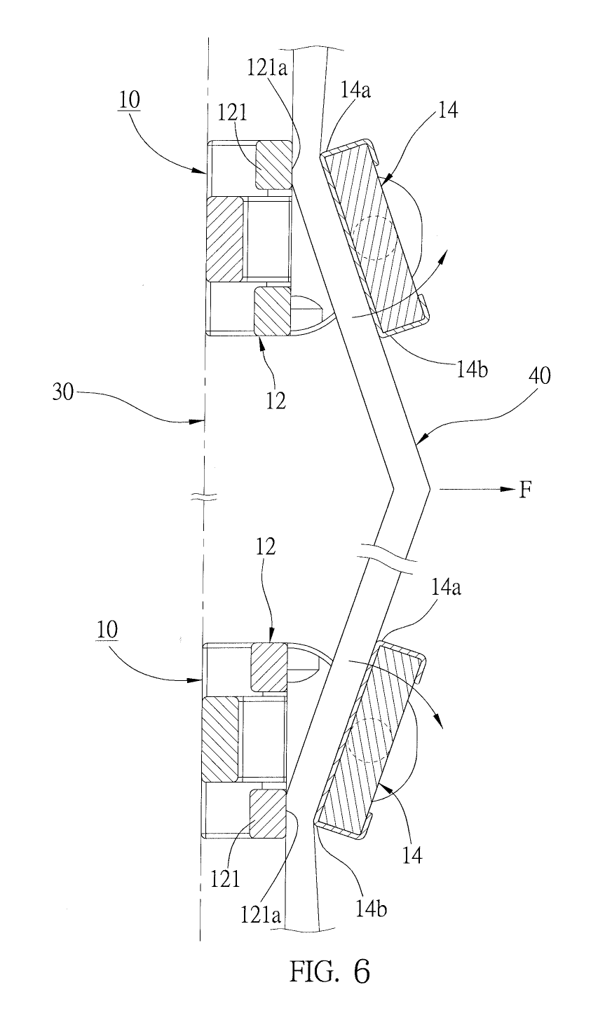

As shown in FIG. 6, while one is holding the cord 40 between two cord locker, and pulling the cord 40 with a force F, it will turn the rotary members 14 of the cord lockers 10 above and under in opposite directions. At the same time, the top end 14a of the rotary member 14 of the cord locker 10 above and the bottom end 14b of the rotary member 14 of the cord locker 10 under will be moved toward the resting faces 121a , thus to press the cord 40 onto the resting faces 121a. As a result, the cord 40 will be securely locked and is unable to be pulled out anymore. The movements of the rotary members 14 are happening in a very short time, so that there is a short portion of the cord 40 being pulled out only, and that portion of the pulled out cord shall not be a strangulation hazard for a kid.

In FIG. 1, the shade member is constructed by transverse bamboo strips. The shade member may be constructed by blanket, e.g. fabric blaket, as well. Typically, the blanket is provided with a plurality of transverse poles at the back side thereof.

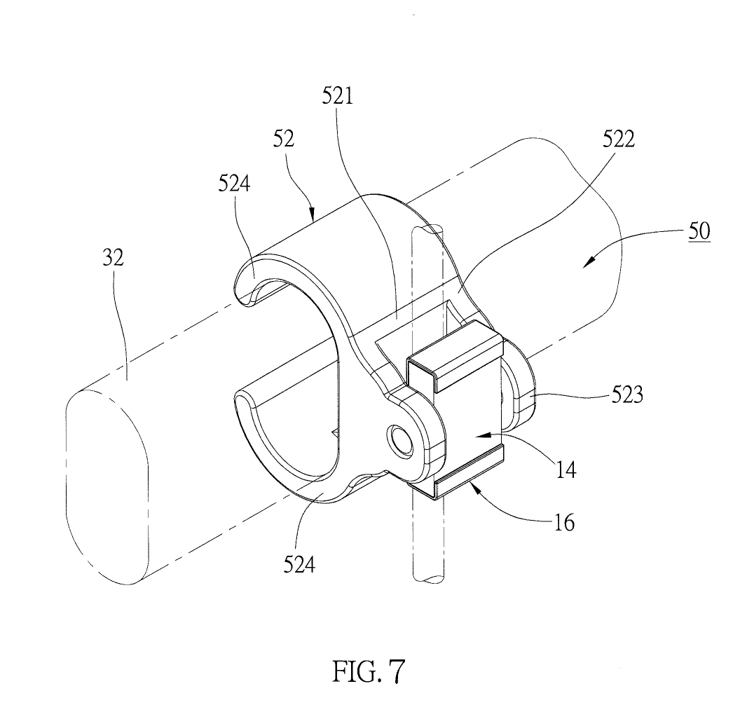

FIG. 7 shows a cord locker 50 of the second preferred embodiment of the present invention, which includes the rotary member 14 and the wear-resisting member 16. The cord locker 50 is provided with a connecting member 52 at a back side of a base 50 instead of the connector 18. The base 50, the same as above, has a transverse plate 521, two lateral plates 522 and two protrusions 523. The connecting member 52 has two arched clipping arms 524 projected from the back side of the transverse plate 521 to form a clipping space therebetween. The clipping arms 524 are able to clip to a transverse pole 32 of the shade member 30 to secure the cord locker 50 to the back side of the shade member 30. The connecting member 52 could be any kind of conventional connector, such as O-ring, C-ring or U-shaped clipper. The connecting member 52 connects the base 50 to the shade member 30, and makes it unable to rotate.

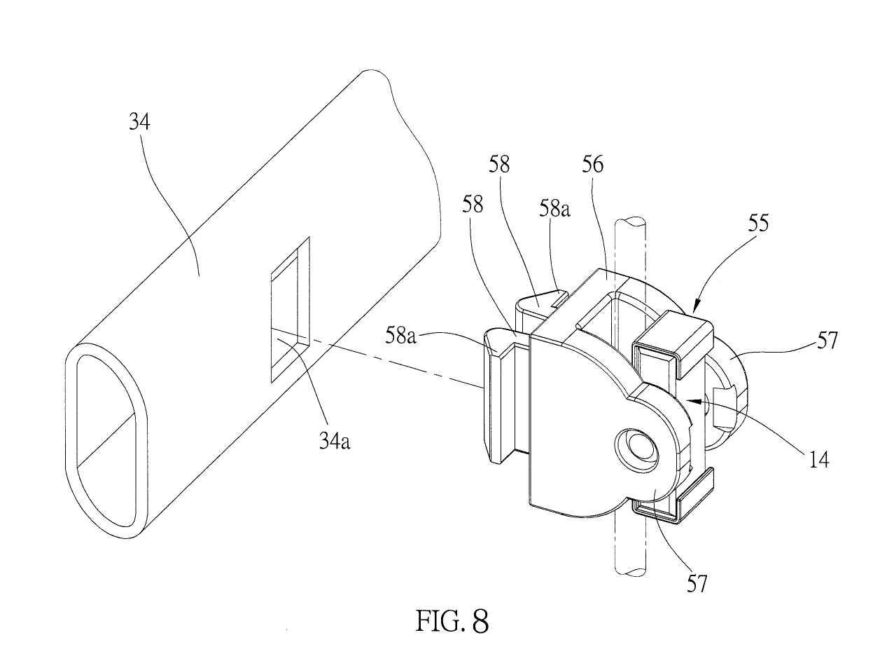

FIG. 8 shows a cord locker 55 of the third preferred embodiment of the present invention, which is directly connected to a transverse pole 34 of the shade member 30 (not shown) without the connector 18. The transverse pole 34 is a hollow pole with a bore 34a. The cord locker 55 has a transverse plate 56, on opposite sides of which two protrusions 57 and two clipping arms 58 are provided. The clipping arms 58 are directly projected from a back of the transverse plate 56. Each clipping arm 58 has a hook 58a at a distal end thereof. The hooks 58a of the clipping arms 58 engage the bore 34a of the transverse pole 34 to connect the cord locker 55 to the back side of the shade member. The same as above, the rotary member 14 is pivoted on the protrusions 57 for free swing.

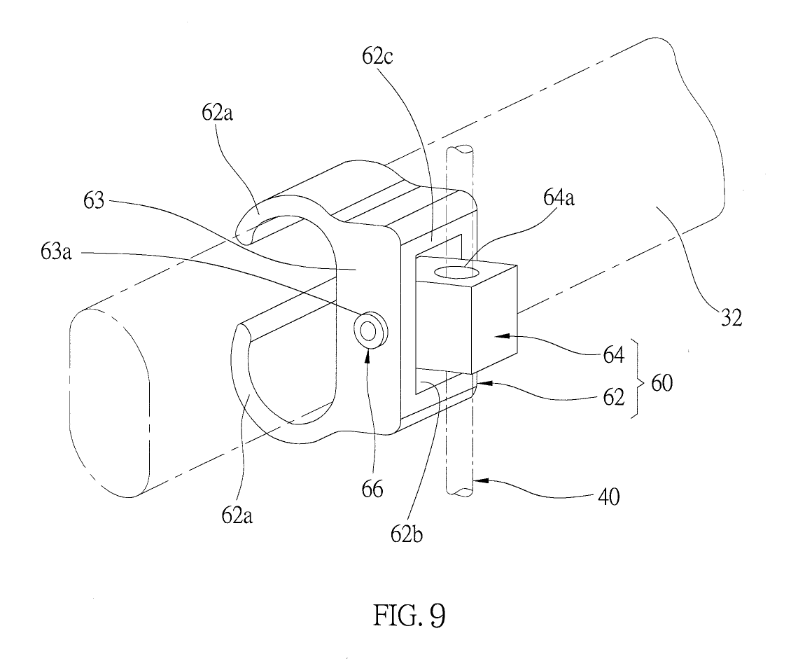

FIG. 9 shows a cord locker 60 of the fourth preferred embodiment of the present invention, which includes a base 62, a rotary member 64. The same as the second preferred embodiment, the base 62 has two clipping arms 62a to secure the base 62 to the transverse pole 32. The base 62 has two protrusions 63 and a bore 62b between the protrusions 63. Each protrusion 63 has a hole 63a communicated with the bore 62b. The rotary member 64 has a portion received in the bore 62b. The rotary member 64 has a post 66 to engage the holes 63a to pivot the rotary member 64 on the base 62. The rotary member 64 has a portion out of the base 62, on which a cord hole 64a is provided. The cord 40 passes through the cord hole 64a. If the cord 40 is pulled, it will turn the rotary member 64 and make the rotary member 64 press the cord 40 onto a resting face 62c of the base 62. As a result, the cord 40 will be securely locked and unable to be pulled anymore.

With the designs of above, the cord locker of the present invention provides the rotary member to be moved by the cord and to securely lock the cord at the same time when the cord is pulled. If the cord is pulled harder, the rotary member will provide a greater strength to secure the cord accordingly. With the cord locker of the present invention, there will be no need to have the double-layer valance or the cord tube used in a conventional roman shade. Therefore, the cost will be reduced.

The description above is only a few preferred embodiments of the present invention and the equivalence of the present invention is still in the scope of claim construction of the present invention.

What is claimed is:

1. A cord locker of a roman shade, comprising:
a base having two protrusions and a resting face, wherein the protrusions are on the same side of the base and face each other;
a rotary member pivoted on the base and between the protrusions, wherein the rotary member has a top end and a bottom end, whereby a distance between the top end and the resting face and a distance between the bottom end and the resting face are changeable when the rotary member is turned.

2. The cord locker as defined in claim 1, wherein each protrusion of the base has a hole; the rotary member has a board and two posts on opposite sides of the board; and the posts engage the holes of the protrusions respectively.

3. The cord locker as defined in claim 2, further comprising a wear-resisting member attached to the rotary member and facing the resting face of the base.

4. The cord locker as defined in claim 2, wherein the base has a transverse plate and two lateral plates on opposite ends of the transverse plate; the resting face is formed on a side of the transverse plate; and the protrusions are provided on the lateral plates respectively.

5. The cord locker as defined in claim 4, further comprising a connector having two arms and two hooks on distal ends of the arms, wherein the transverse plate has a bore, and each lateral plate has an opening; and the arms of the connector pass through the bore of the transverse plate, and then the hooks engage the openings of the lateral plates respectively.

6. The cord locker as defined in claim 4, further comprising at least a clipping arm on the transverse plate of the base, wherein the clipping arm is on a side which is opposite to the resting face.

7. The cord locker as defined in claim 4, further comprising two clipping arms on the transverse plate of the base, wherein the clipping arms are on a side which is opposite to the resting face, and a clipping space is formed between the clipping arms.

8. The cord locker as defined in claim 4, further comprising two clipping arms on the transverse plate of the base, wherein the clipping arm is on a side which is opposite to the resting face, and each clipping arm has a hook on a distal end thereof.

9. The cord locker as defined in claim 1, wherein the base has a bore, and each protrusion has a hole communicated with the bore; the rotary member has a portion received in the bore and has a portion out of the bore; a post is provided on the portion of the rotary member in the bore to engage the holes of the protrusions; a cord hole is provided on the portion of the rotary member out of the bore for a cord passing there through.
